(19) United States
(12) Patent Application Publication
(10) Pub. No.: US 2003/0058506 A1
(43) Pub. Date: Mar. 27, 2003

(54) Optical free space signalling system

(76) Inventors: Alan Eward Green, Cambridgeshire (GB); Euan Morrison, Cambridgeshire (GB); Andrew Mark Parkes, Cambridgeshire (GB); Gordon Malcolm Edge, Cambridgeshire (GB)

Correspondence Address: FINNEGAN, HENDERSON, FARABOW, GARRETT &, DUNNER LLP, 1300 I STREET, NW, WASHINGTON, DC, 20006, US

(21) Appl. No.: 10/168,571

(22) PCT Filed: Dec. 22, 2000
(86) PCT No.: PCT/GB00/04980

(30) Foreign Application Priority Data
Dec. 22, 1999 (GB) 9930434.7
Jul. 27, 2000 (GB) 0018488.7
Oct. 20, 2000 (GB) 0025807.9

(51) Int. Cl. H04B 10/00

(52) U.S. Cl. 359/172; 359/154

(57) ABSTRACT

There is described a signalling system operable to transmit data to a moving vehicle. The signalling system includes a first signalling device which is movable relative to a second signalling device by virtue of the first signalling device being mounted to a movable vehicle. One of the first and second signalling devices comprises a light source, a lens system for directing a light beam emitted by the light source in an exit direction within a field of view of the lens system, a detector for detecting the presence of the other signalling device, and means for varying the exit direction to align the optical beam with said other signalling device. By including the varying means, a low divergence light beam can be used which advantageously reduces the total power requirements. There is also described a financial transaction system in which low divergence free-space light beam is used to convey financial data. By using a low divergence light beam it is difficult for an eavesdropper to intercept the financial data.

This invention relates to a signalling system. One aspect of the invention relates to an optical free space signalling method and apparatus for transferring data to and from a road vehicle. Another aspect of the invention relates to an optical free space signalling method and apparatus for providing a secure communication link.

In recent years a number of systems have been proposed for transferring data to a road vehicle. For example, in the United Kingdom local traffic information is broadcast at radio frequencies so that drivers can hear the local traffic information using a car radio.

A large amount of research has also been carried out in recent years into secure data links for handling the transfer of data in financial transactions.

An aim of a first aspect of the invention is to provide an alternative communications link for communicating data to and from a road vehicle.

An aim of a second aspect of the invention is to provide an alternative secure communications link for communicating, for example, data relating to financial transactions.

In accordance with the first aspect of the invention, there is provided a signalling system in which data is transferred between a first signalling device which is movable relative to a second signalling device by virtue of the first signalling device being mounted to a movable vehicle. One of the first and second signalling devices comprises: (i) a light source for emitting a light beam; (ii) a lens system for collecting the light beam emitted by the light source and directing the light beam in an exit direction within a field of view of the lens system; (iii) a detector for detecting the presence of the other signalling device within the field of view; and (iv) means for varying the exit direction within the field of view to enable alignment of the optical beam with said other signalling device. By replacing a high divergence light beam with a low divergence light beam whose direction can be varied, the total power requirements for the light source are reduced.

In accordance with the second aspect of the invention, there is provided a financial transaction system in which data relating to a financial transaction is transferred between a first and second signalling devices, the first signalling device associated with a first party to the financial transaction and the second signalling device associated with a second party to the financial transactions. The data is transmitted by modulating a substantially collimated light beam. In this way, the party receiving the data can detect the entirety of the light beam and can therefore monitor for any reduction in the power of the light beam caused by an eavesdropper attempting to divert a portion of the light beam.

Exemplary embodiments of the present invention will now be described with reference to the accompanying drawings in which:

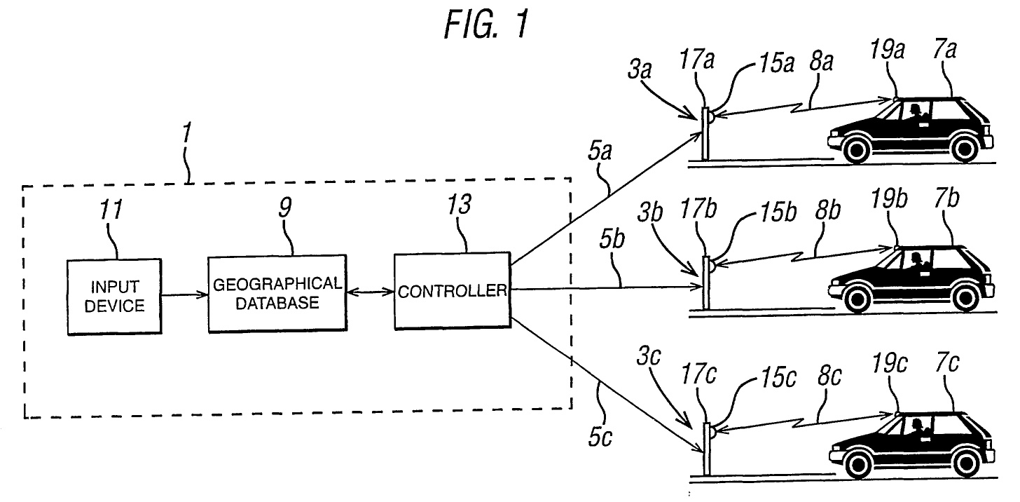

FIG. 1 is a schematic diagram of a system for distributing data to road vehicles;

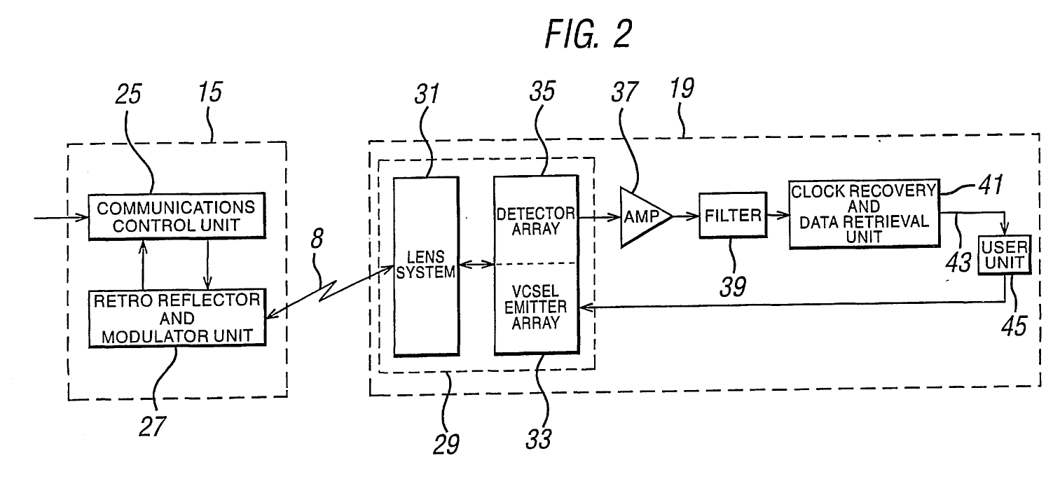

FIG. 2 is a schematic block diagram illustrating the form of a roadside unit and a car terminal which can be used in the data distribution system shown in FIG. 1;

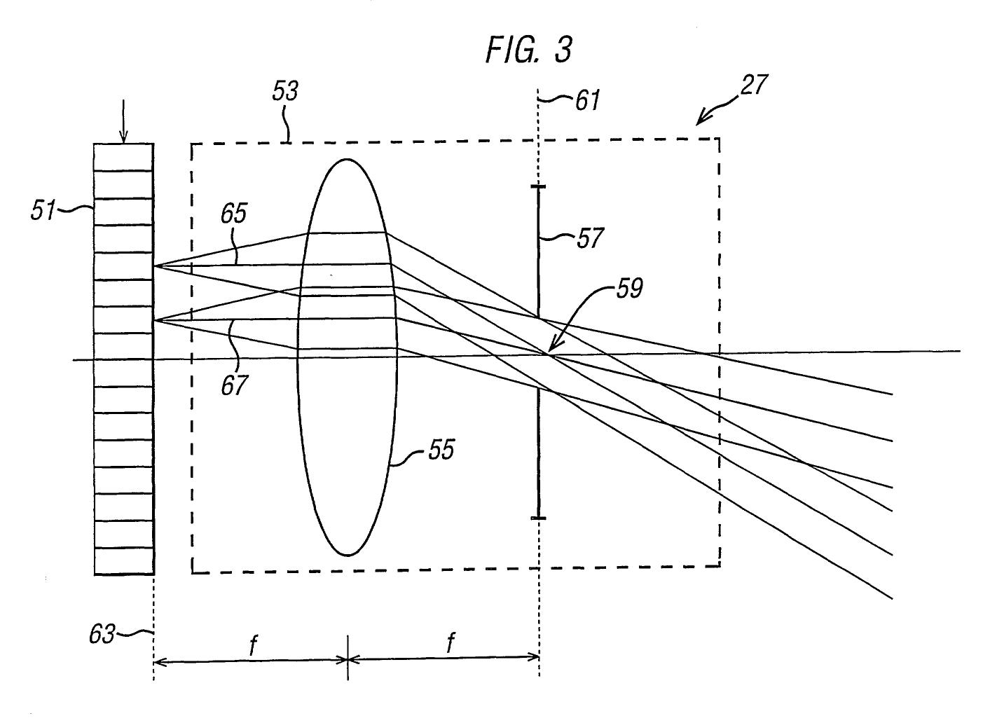

FIG. 3 is a schematic diagram of a retro-reflector and modulator unit which forms part of the roadside unit illustrated in FIG. 2;

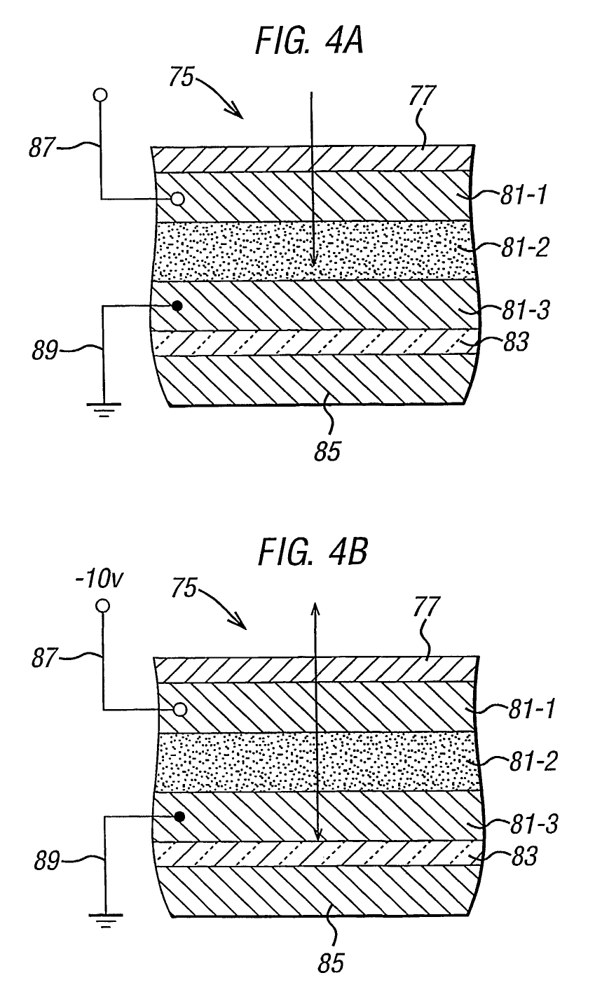

FIG. 4A is a cross-sectional view of one modulator of a pixilated modulator shown in FIG. 3 in a first operational mode when no DC bias is applied to electrodes thereof;

FIG. 4B is a cross-sectional view of one modulator of the pixilated modulator shown in FIG. 3 in a second operational mode when a bias voltage is applied to the electrodes;

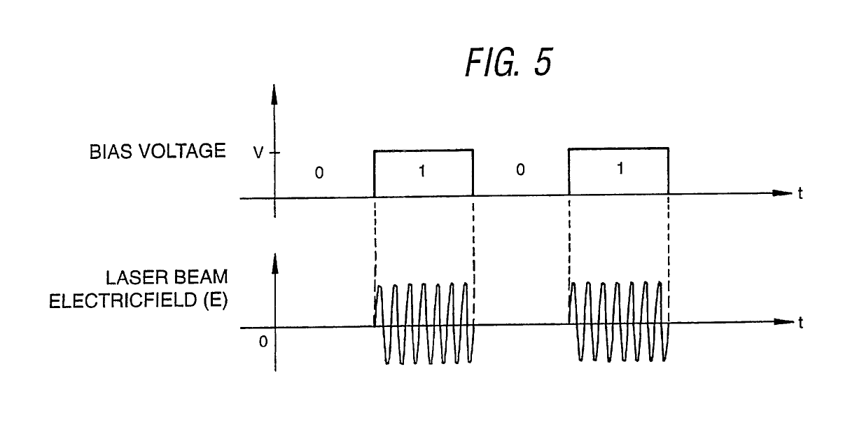

FIG. 5 is a signal diagram which illustrates the way in which the light incident on a pixel of the modulator shown in FIG. 3 is modulated in dependence upon the bias voltage applied to the pixel electrodes;

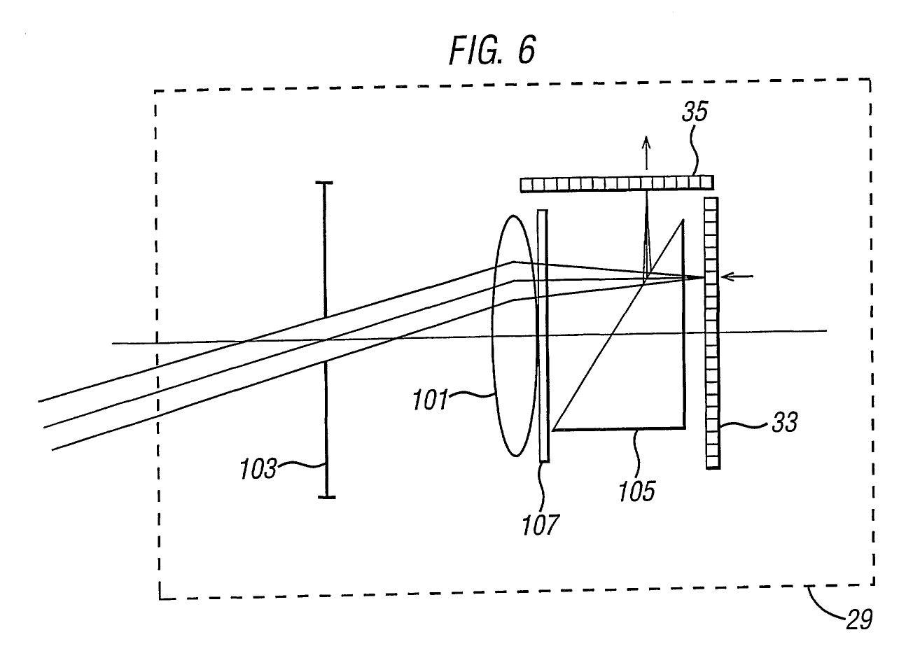

FIG. 6 is a schematic diagram illustrating the form of an emitter and detector array of the car terminal illustrated in FIG. 2;

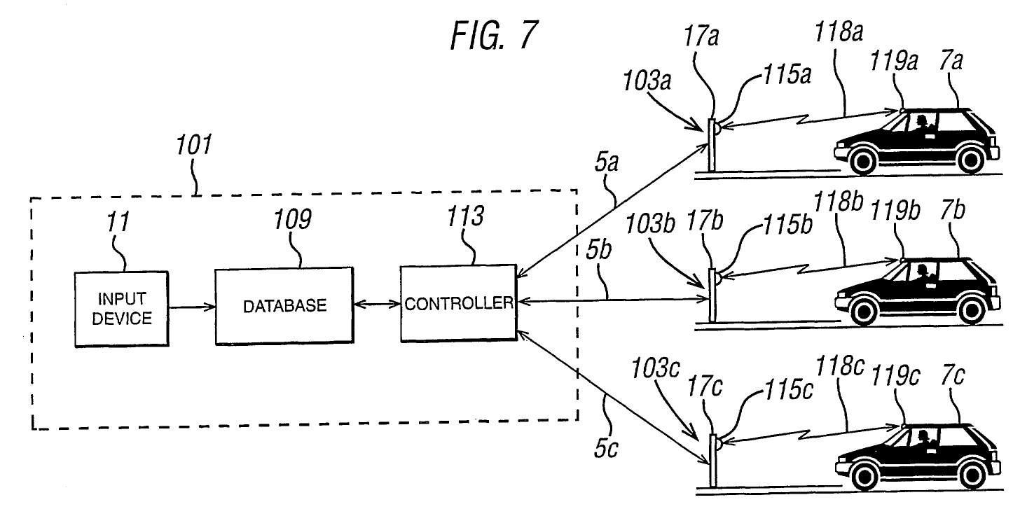

FIG. 7 is a schematic diagram of a first alternative data distribution system;

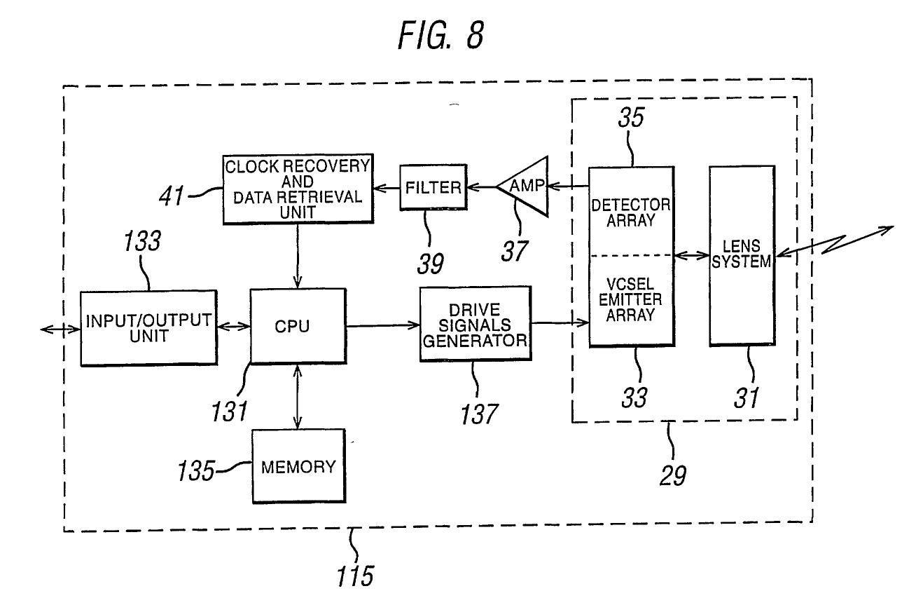

FIG. 8 is a block diagram illustrating the form of a roadside unit of the first alternative data distribution system shown in FIG. 7;

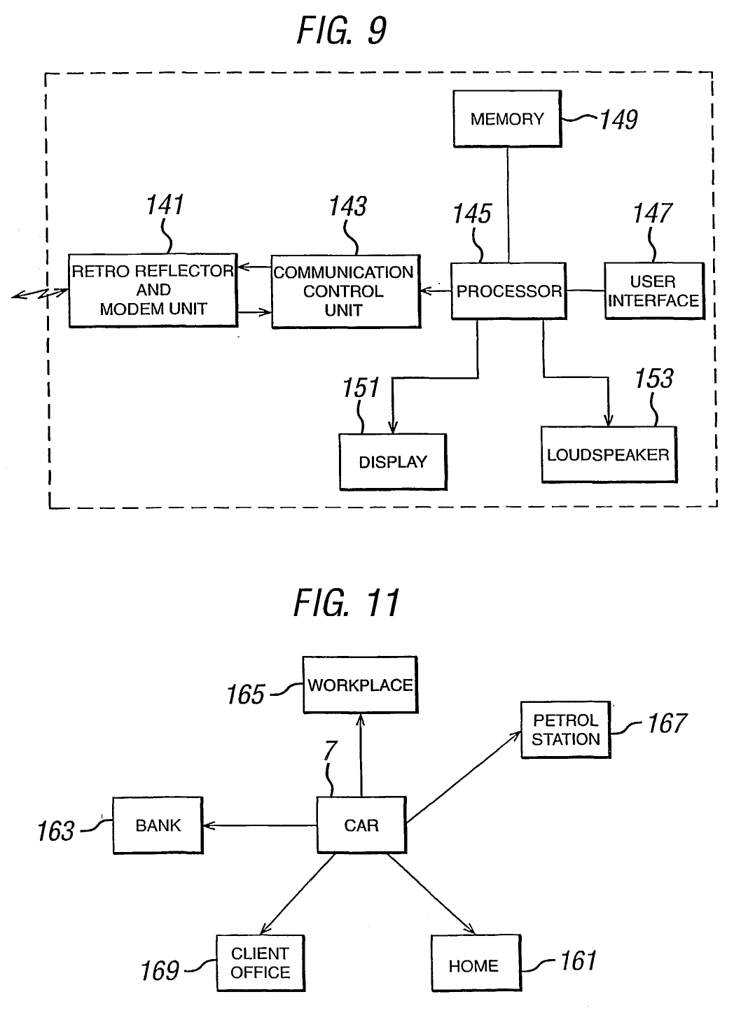

FIG. 9 is a schematic block diagram illustrating the form of a car terminal of the first alternative data distribution system shown in FIG. 7;

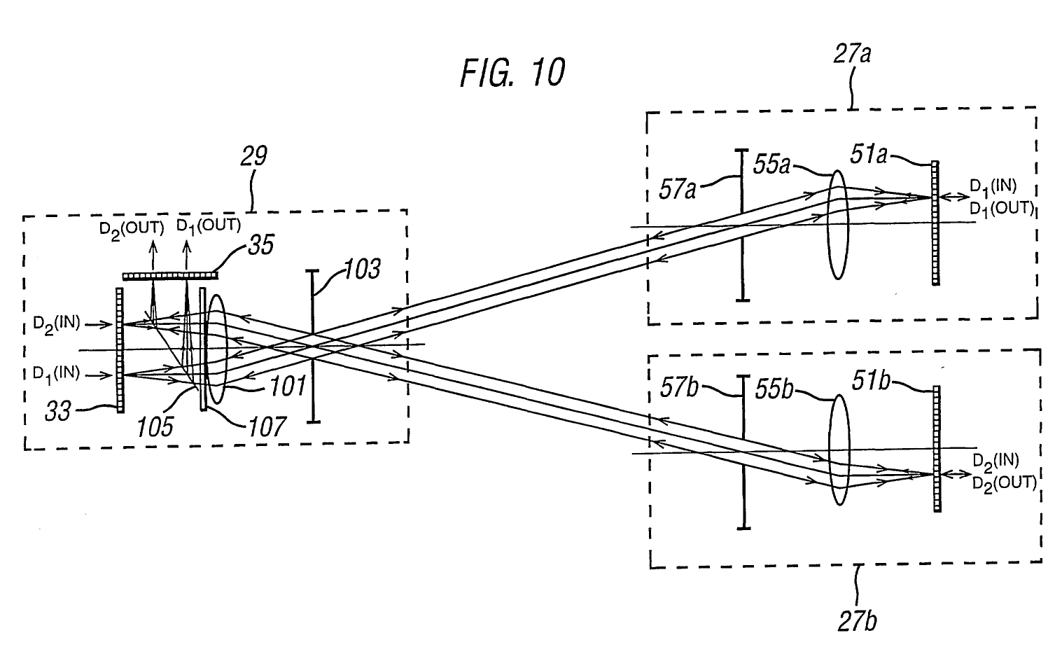

FIG. 10 is a schematic diagram of a second alternative data distribution system;

FIG. 11 is a schematic diagram illustrating typical journeys by car;

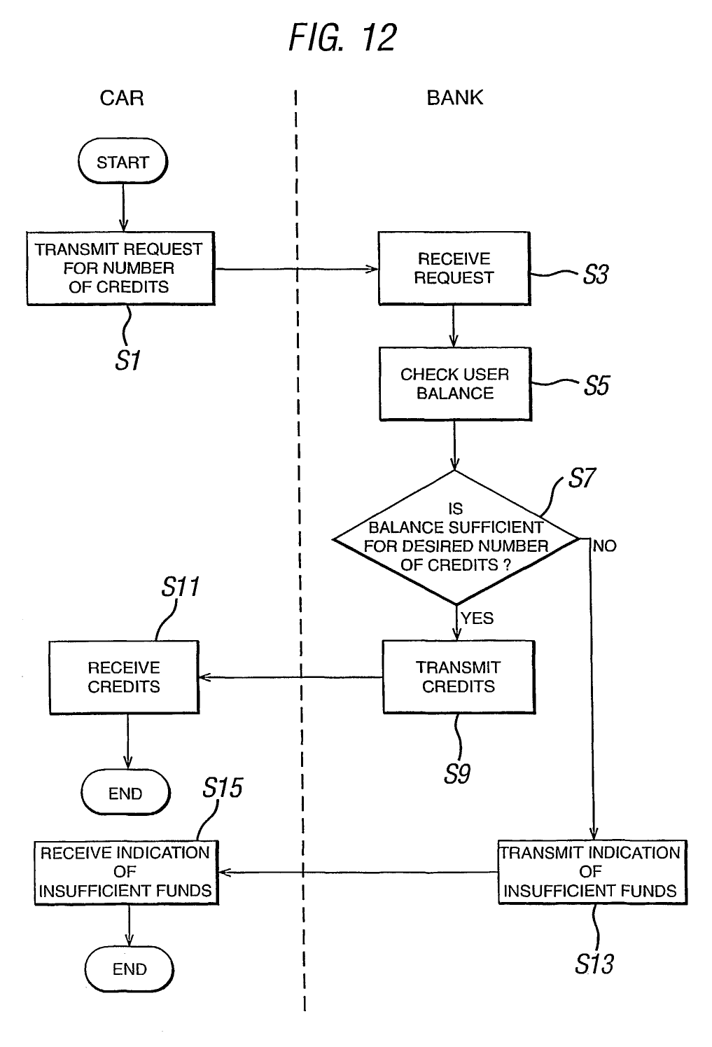

FIG. 12 is a flow chart illustrating the transfer of credits from a credit bank to a car;

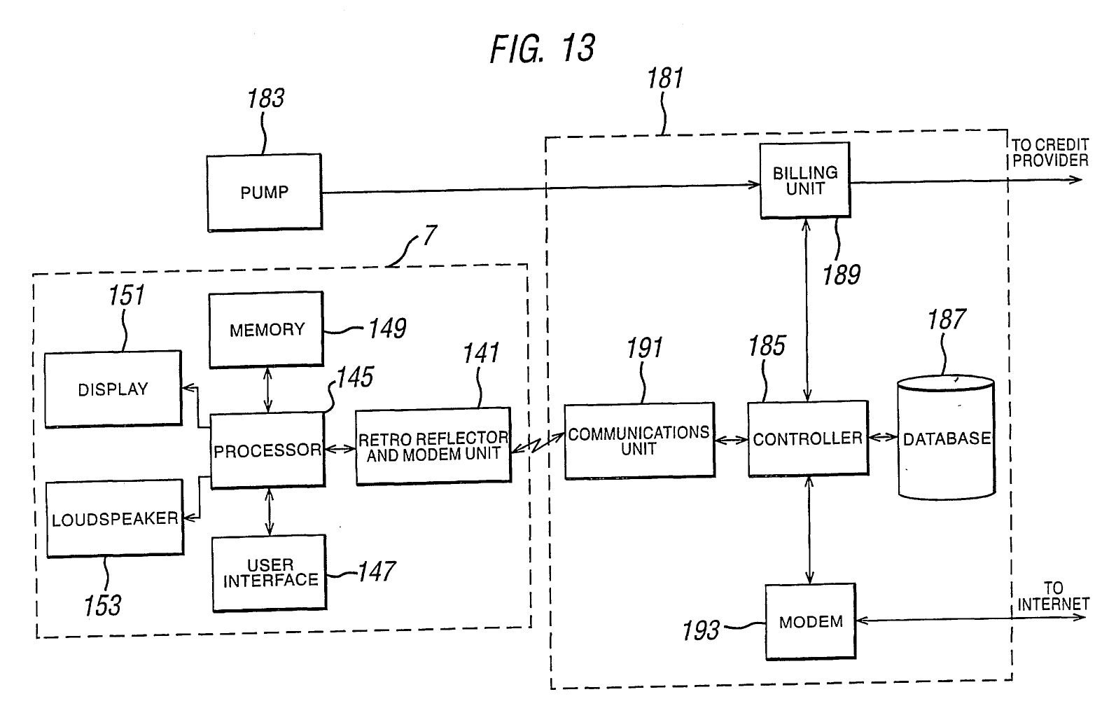

FIG. 13 is a schematic block diagram illustrating a system for transmitting data between a car and a computer network at a petrol station;

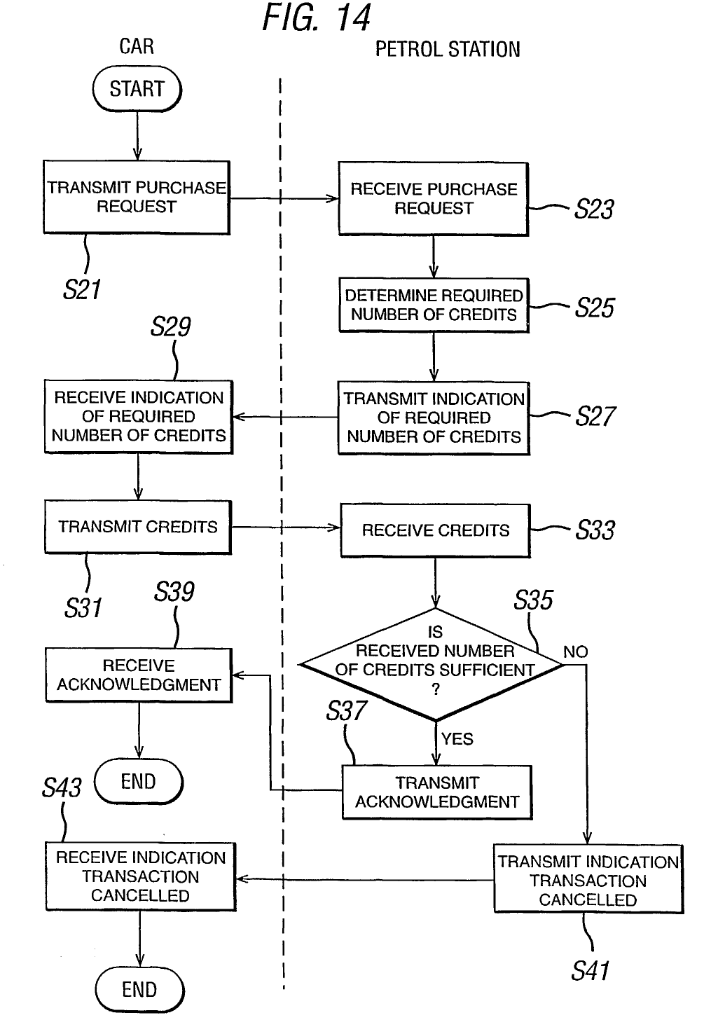

FIG. 14 is a flow chart illustrating the steps performed to carry out a purchase using the system shown in FIG. 13 by transferring credits from the car to the computer network at the petrol station;

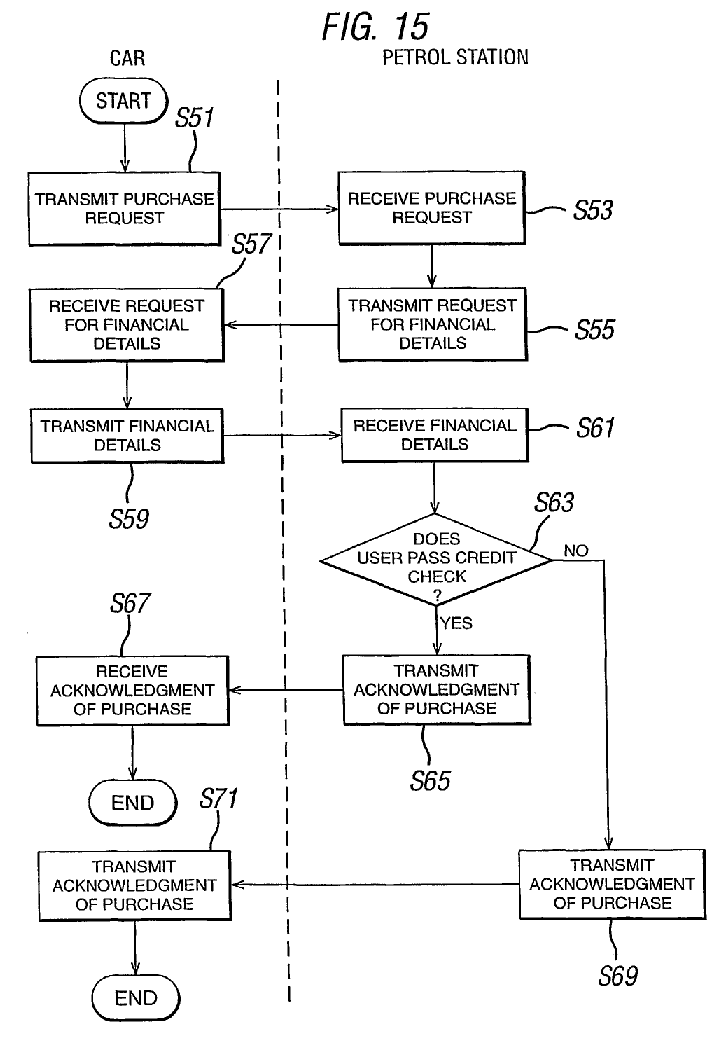

FIG. 15 is a flow chart illustrating the steps performed to carry out a purchase using the system shown in FIG. 13 by transferring financial details from the car to the computer network at the petrol station;

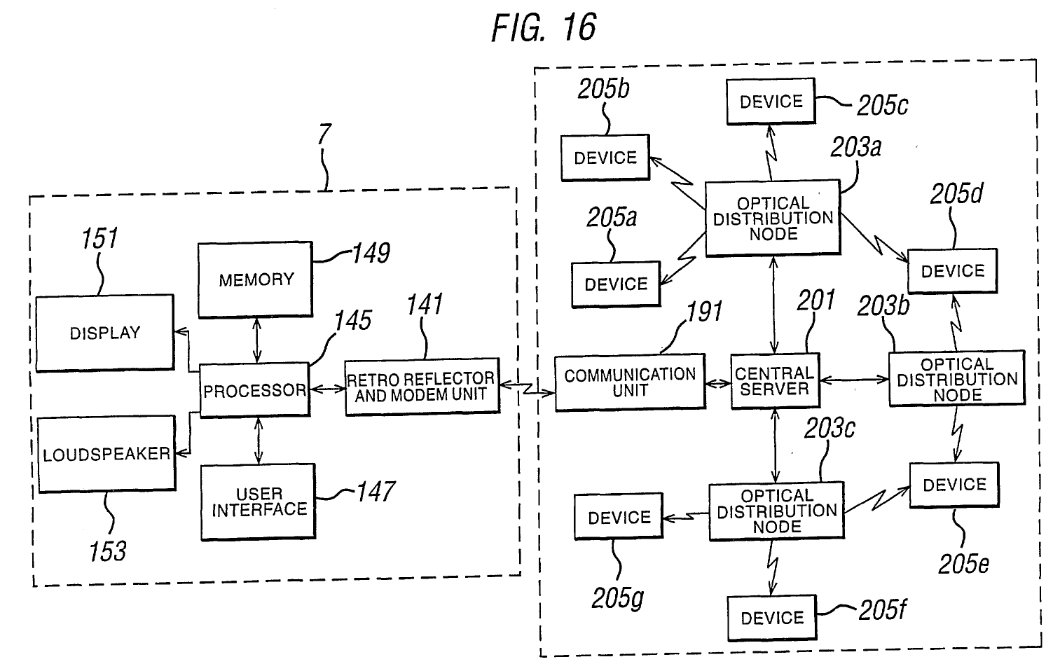

FIG. 16 is a schematic block diagram illustrating a system for transmitting data between a car and a computer network at a house;

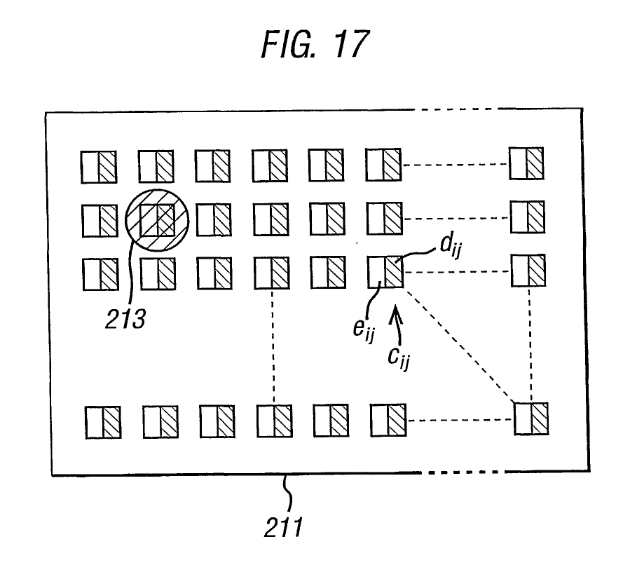

FIG. 17 is a schematic diagram of an alternative emitter and detector array for the car terminal shown in FIG. 1 or the roadside unit shown in FIG. 8;

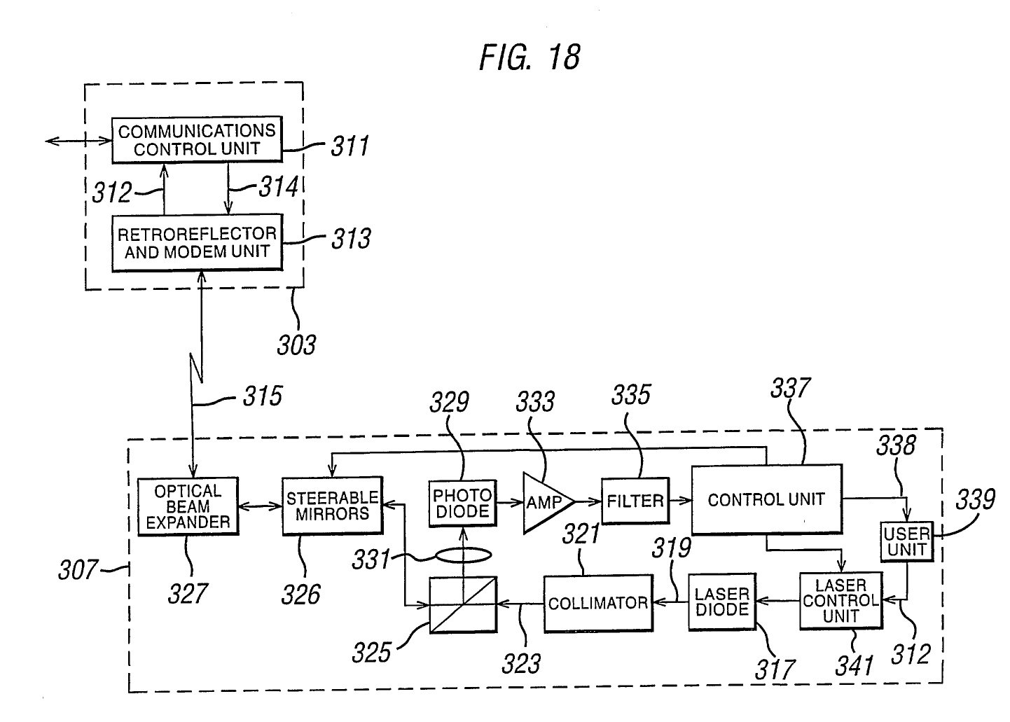

FIG. 18 is a schematic block diagram showing the contents of the roadside unit and the car terminal in a fourth alternative data distribution system;

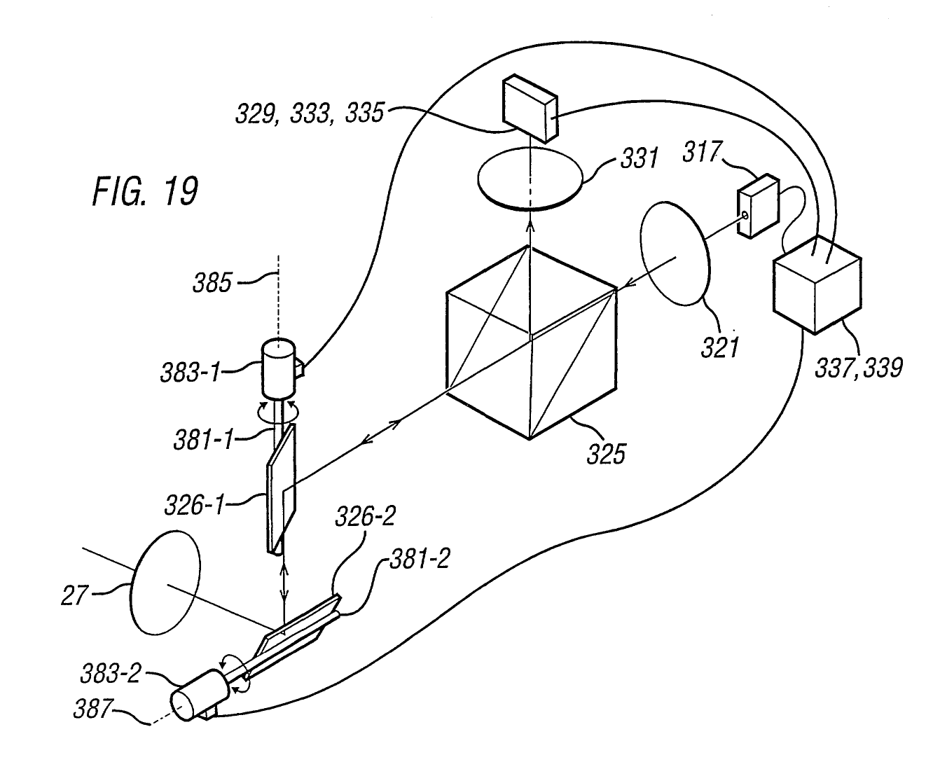

FIG. 19 is a perspective schematic view of some of the components in the car terminal shown in FIG. 18; and

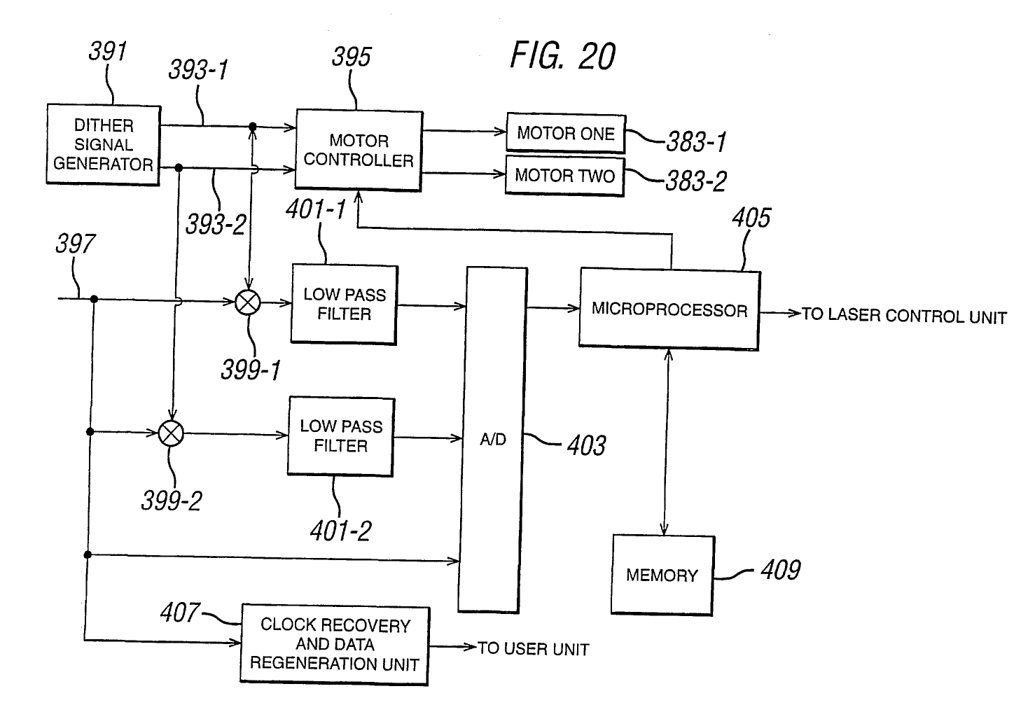

FIG. 20 is a block diagram illustrating a control circuit which forms part of the car terminal shown in FIG. 19.

FIG. 1 schematically illustrates a first embodiment of a data distribution system which employs a point to multipoint signalling system to supply data signals to a plurality of road vehicles. As shown in FIG. 1, the system comprises a central distribution system 1 which transmits optical data signals to a plurality of local distribution nodes 3a to 3c via respective optical fibres 5a to 5c. At the local distribution nodes 3, the optical data signals received from the central distribution system 1 are transmitted to respective cars 7a to 7c as optical signals 8a to 8c through free space, i.e. not as optical signals along an optical fibre path. This kind of simplex data distribution system can be employed to distribute high bandwidth video data or low bandwidth data such as current traffic or weather conditions. The cars 7 include a display unit (not shown) for displaying the video data or car/traffic information to the driver or a passenger in the car 7.

As shown in FIG. 1, the central distribution system 1 comprises a geographical database 9 which stores local information for a plurality of local areas. In this embodiment, the stored local information includes local maps and local traffic and weather information. An input device 11 is connected to the geographical database 9 to enable the data stored in the geographical database 9 to be updated from time to time. A controller 13, which is also connected to the geographical database 9, accesses the local information stored in the geographical database 9, and transmits the local information to each local distribution node 3.

In this embodiment, the total area covered by the data distribution system is separated into a plurality of zones, and a plurality of local distribution nodes 3 are located in each of the zones. For each zone, the controller 13 searches the geographical data base 9 for all information relevant to that zone, and then transmits the relevant information to every local distribution node 3 within the zone.

Each local distribution node 3 includes an optical communication device 15a to 15c, hereinafter referred to as a roadside unit 15, mounted on a post 17a to 17c which is positioned by the side of a road. Each of the cars 7 also has a car terminal 19a to 19c which includes an optical communication device. In this embodiment, each car terminal 19 outputs a free-space, unmodulated optical beam which is modulated in the roadside unit 15 in accordance with the optical data signal received from the central distribution system 1. The roadside unit 15 then directs the modulated optical beam back to the car terminal 19 which sent the corresponding unmodulated optical beam where it is detected and converted into a corresponding electrical signal. In this way, local information stored in the geographical database 9 of the central distribution system 1 is transmitted to the car 7.

In this embodiment, the free-space optical beams emitted by the car terminals 19 have a low divergence and are directed in a specific direction, rather than being generally broadcast. This enables data to be conveyed at a rate of 5 Gigabits per second between the roadside unit 15 and the car 7. The car terminal 19 is able to vary the direction of the emitted optical beam within a comparatively broad “field of view” and when no incoming optical beam from a roadside unit 15 is detected the car terminal 19 continuously scans the emitted optical beam throughout the field of view until it receives a signal back from the roadside unit 15. In this embodiment, the field of view of each car terminal 19 is cone-shaped with the apex of the cone located at the car terminal 19.

The ability to vary the direction of the optical beam emitted from the car terminal 19 also enables the communication link between the car terminal 19 and the roadside unit 15 to be maintained even when the car 7 is moving. Due to the high possible data rates, a significant amount of information can be transferred even if the car is moving at a considerable speed. For example, if the car 7 is travelling along the road at 70 km per hour and the field of view of the roadside unit 15 covers 100 m of the road, then the roadside unit 15 will be within the field of view for about 5 seconds. Even if the optical link is only established for one second, at a data rate of 5 Gigabits per second this would enable up to 5 Gigabits of information to be transmitted from the roadside unit 15 to the car 7.

FIG. 2 illustrates in more detail the form of the roadside unit 15 and the car terminal 19 used in this embodiment. As shown, in this embodiment the roadside unit 15 includes a communications control unit 25 which is operable to receive the data transmitted by the central distribution system 1 via the optical fibres 5. The communications control unit 25 is connected to a retro-reflector and modem unit 27, such as the one disclosed in International Patent Application WO 98/35328 (the contents of which are incorporated herein by reference), which is controlled by the communications control unit 25 to modulate an incident optical beam in accordance with the data received from the central distribution system 1 and direct the modulated optical beam back along its path of incidence.

As shown in FIG. 2, in this embodiment the car terminal 19 includes an emitter and detector array and lens system 29 comprising a lens system 31, an emitter array 33 and a detector array 35. In this embodiment, the emitter array 33 comprises a two-dimensional pixelated array with a vertical cavity surface emitting laser (VCSEL) positioned in each pixel. The use of VCSELs is preferred because the emitter array 33 can then be manufactured from a single semiconductor wafer, without having to cut the wafer. This allows a higher density of lasing elements than would be possible with traditional diode lasers. VCSEL arrays which output laser beams having a wavelength in the region of 850 nm within the power range of between 1 mW and 30 mW are available from CSEM SA, Badenerstrasse 569, 8048 Zurich, Switzerland.

In this embodiment, each VCSEL in the emitter array 33 can output an unmodulated linearly-polarised divergent light beam, the divergence being primarily caused by diffraction at the emitting aperture of the VCSEL, which is collimated by the lens system 31 to reduce the divergence and directed in a respective direction within the field of view of the lens system 31 to form the low divergence optical light beam 8. Since the light emitted from each pixel is mapped to a different angular direction within the field of view of the lens system 31, by selectively driving the emitter elements in the VCSEL array 33, the direction of the emitted light beam within the field of view can be varied. The lens system 31 also focusses a modulated light beam received back from the roadside unit 15 onto the detector array 35. In this embodiment, the detector array 35 is a two-dimensional array of photodiodes.

The electrical signals output by the detector array 35, which will vary in dependence upon the data conveyed by the modulated light beam, are amplified by an amplifier 37 and then filtered by a filter 39. The filtered signals are then supplied to a clock recovery and data retrieval unit 41 which regenerates the clock and the original data using standard processing techniques. The received data 43 is then input to a user unit 23 which, in this embodiment, comprises a display on which the data is displayed to the driver or a passenger in the car 7.

FIG. 3 schematically illustrates the retro-reflector and modulator unit 27 which is used in this embodiment. As shown, the retro-reflector and modulator unit 27 comprises a modulator array 51 and a telecentric lens system 53 formed by a lens 55 and a stop member 57, having a central aperture 59, which is optically located in the front focal plane 61 of the lens 55. Those skilled in the art will appreciate that in practice more than one lens element is likely to be used, the exact arrangement being a design choice depending on the particular requirements of installation, but for ease of illustration only one lens element is shown in FIG. 3. The size of the aperture 59 is also a design choice which depends upon the particular requirements of the installation. In particular, a small aperture 59 results in most of the light from the sources being blocked (which results in a significant transmission loss) but does not require a large expensive lens to focus the light. In contrast, a large aperture will allow most of the light from the sources to pass through but requires a larger and hence more expensive lens system 53. However, there is generally little benefit in increasing the size of the aperture beyond the point where the transmission loss of the lens system 53 becomes negligible in comparison with atmospheric loss of the free space optical beam.

The modulator array 51 is positioned in the back focal plane of the telecentric lens system 53. Due to the telecentricity of the telecentric lens system 53, the light incident on the lens is focussed on the back focal plane 63 in such a way that the principal rays 65 and 67 which emerge from the lens system 53 are perpendicular to the back focal plane 63. This enbles the modulator array 51 to act as a retro-reflector. Those skilled in the art will appreciate that the use of the telecentric lens system 53 is advantageous because the modulator array 51 can then be formed using conventional planar semiconductor processing techniques.

A problem with existing optical modulators is that the efficiency of the modulation, i.e. the modulation depth, generally depends upon the angle with which the laser beam hits the modulator. By using the telecentric lens system 53 and by placing the modulator array 51 at the back focal plane 63 of the telecentric lens system 53, the principal rays of the laser beams will be incident parallel to the optical axis of the modulators regardless of the position of the car terminal 19 within the retro-reflector's field of view. Consequently, a high efficiency of modulation will be achieved.

In this embodiment, the modulator array 51 comprises a two-dimensional array of Quantum Confined Stark Effect (QCSE, sometimes also referred to as Self Electro-optic Devices or SEEDs) modulators developed by the American Telephone and Telegraph Company (AT&T).

FIG. 4A schematically illustrates the cross-section of the QCSE device 75. As shown, the QCSE device comprises a transparent window 77 through which the laser beam from the appropriate car terminal 19 can pass followed by three layers 81-1, 81-2 and 81-3 of Gallium Arsenide (GaAs) based material. Layer 81-1 is a p conductivity type layer, layer 81-2 is an intrinsic layer having a plurality of quantum wells formed therein, and layer 81-3 is an n conductivity type layer. Together, the three layers 81-1, 81-2 and 81-3 form a p-i-n diode. As shown, the p conductivity type layer 81-1 is connected to the electrode 87 and the n conductivity type layer 81-3 is connected to the ground terminal 89. As shown in FIG. 4A, a reflective layer 83 is provided beneath the n type conductivity layer 81-3 and beneath this a substrate layer 85.

In operation, the laser beam from the car terminal 19 passes through the window 77 into the gallium arsenide based layers 81. Depending upon DC bias voltage applied to the electrode 87, the laser beam is either reflected by the reflective layer 83 or it is absorbed in the intrinsic layer 81-2. In particular, when no DC bias is applied to the electrode 87, as illustrated in FIG. 4a, the laser beam passes through the window 77 and is absorbed within the intrinsic layer 81-2. Consequently, when there is no DC Bias voltage applied to the electrode 87, no light is reflected back to the corresponding car terminal 19. On the other hand, when a DC bias voltage of approximately −10 volts is applied to the electrode 87, as illustrated in FIG. 4b, the laser beam from the corresponding car terminal 19 passes through the window 77 and is reflected by the reflecting layer 83 back upon itself along the same path to the corresponding car terminal 19.

Therefore, by changing the bias voltage applied to the electrode 87 in accordance with the modulation data to be transmitted to the car terminal 19, the QCSE modulator 75 will amplitude modulate the received laser beam and reflect the modulated beam back to the car terminal 19.

Ideally, the light which is incident on the QCSE modulator 75 is either totally absorbed therein or totally reflected thereby. In practice, however, the QCSE modulator 75 will reflect typically 70% of the laser beam 79 when no DC bias is applied to the electrodes 87 and 89 and 95% of the laser beam 79 when the DC bias is applied to the electrodes 87 and 89. Therefore, in practice, there will only be a difference of about 25% in the amount of light which is directed onto the detector array 35 when a binary zero is being transmitted and when a binary 1 is being transmitted.

The amount of the received light beam absorbed by the intrinsic layer 81-2 can be increased by adding additional quantum wells to increase the depth of the intrinsic layer 81-2. However, if the depth of the intrinsic layer 81-2 is increased, then a higher voltage must be applied to the electrode 87 in order to achieve the required electric field across the intrinsic layer 81-2 in order to allow the intrinsic layer 81-2 to transmit the received light beam. There is, therefore, a trade off between the absorptivity of the intrinsic layer 81-2 and the voltage applied to the electrode 87. By using the QCSE modulators 75, modulation rates of the individual modulator cells as high as 2 Gigabits per second can be achieved.

FIG. 6 shows in more detail the emitter and detector array and lens system 29 in the car terminal 19. As schematically shown in FIG. 6, the VCSEL emitter array 33 is positioned in the back focal plane of a telecentric lens system represented by the lens 101 and the stop member 103 in FIG. 6, the stop member 103 being located in the front focal plane of the telecentric lens system. The purpose of employing a telecentric lens system is to ensure that the collection efficiency (of light from the emitter array 33) of the lens 55 is constant across the emitter array 33. Therefore, provided all the emitters are the same, the intensity of the light output from the local distribution node will be the same for each emitter. Whereas, with a conventional lens the intensity of the light output from the local distribution node will be greater for light emitted by emitters in the centre of the array than for those at the edge. The use of a telecentric lens also avoids various cosine forward-off factors which are well known in conventional lenses.

In this embodiment, the linearly-polarised light emitted by a VCSEL in the emitter array 33 is transmitted through a polarisation beam splitter 105 and input to a quarter-wave plate 107 which converts the linearly-polarised light into left-handed circularly polarised light. The light reflected back from the roadside unit 15 will therefore be right-handed circularly polarised light which is converted by the quarter-wave plate 107 into linearly-polarised light whose polarisation is orthogonal to the linearly-polarised light emitted by the emitter array 33. The polarisation beam splitter therefore reflects the light reflected from the roadside unit 33 onto the detector array 35 which is also on the back focal plane of the telecentric lens system 53.

As shown in FIG. 6, in this embodiment only one VCSEL in the emitter array 33 is operated at a time. As discussed above, by changing the VCSEL which is operated it is possible to vary the direction of the emitted beam. Further, the light received from the roadside unit 15 will be focussed at a position on the detector array 35 which corresponds to the direction of the emitted beam. In this embodiment, the signals from the detector array are monitored, and based on the monitored signals a tracking operation is performed in which the VCSEL element which is driven is changed in order to vary the direction of the emitted light beam to maintain the optical link 8 between the car terminal 19 and the roadside unit 15.

In this embodiment, a repeating sequence of 100 Megabits of data is received from the central distribution centre 1 by each roadside unit 19 for transfer to cars 7 driving by each roadside unit 19. Therefore, in the first embodiment a simplex communication system is set up between the roadside units 19 and the cars 7, in which data is only transmitted to the cars 7.

A second embodiment will now be described with reference to FIGS. 7 to 9 in which a duplex communication link is set up between a central distribution system 101 and a plurality of cars 7. In FIGS. 7 to 9, the components which are the same as corresponding components in the first embodiment have been referenced with the same numerals and will not be described again.

The advantage of having a duplex communication link is that each car 7 can request specific information from the central distribution system 101. As shown in FIG. 7, in the duplex communication system each car terminal 119 is able to transmit a request for data to a roadside unit 115 which forwards the request to a controller 113, in the central distribution system 101, which accesses the requested information in a database 109. In this embodiment, the requested information is then transmitted by the controller 113 not just to the roadside unit 115 from which the request originated, but also to neighbouring roadside units 115 so that if the car 7 has passed out of the field of view of the roadside unit 103 via which a request was made, the car 7 can pick up the requested information at the next roadside unit it drives past.

FIG. 8 schematically shows the contents of the roadside unit 115 in the second embodiment. As shown, in the second embodiment an emitter and detector array and lens system 29 is located in the roadside unit 115 (instead of a retro-reflector and modulator unit as in the first embodiment). Amplitude-modulated optical beams from a car terminal 119 are focussed by the lens system 31 onto the detector array 35 which converts the received modulated optical signal into a corresponding electrical signal. In this embodiment, the received optical signal conveys a data signal including identification information identifying the car along with a request for information. The electrical signal is amplified, filtered and processed in the same manner as in the first embodiment to retrieve the data signal. The retrieved data signal is input to a central processing unit (CPU) 131 which forwards the identification information and request to the central distribution system 101 via an input/output unit 133 of the roadside unit 115.

The roadside unit 115 also receives requested information, together with the identification information corresponding to the car 7 which requested the information, from the central distribution system 101 via the input/output unit 133. The information received from the central distribution system 101 is input to a memory 135 until the roadside unit 115 receives a data signal conveying the corresponding identification information, in response to which the CPU 131 extracts the information from the memory 135 and inputs it to a drive signals generator 137 which generates appropriate drive signals for the VCSEL emitter array 33. In particular, the drive signals generator 137 modulates the amplitude of the optical beam emitted by the VCSEL emitter array 33 in accordance with the requested information. In this way the VCSEL emitter array 33 directs a low-divergence optical beam at the appropriate car terminal 119 conveying the requested information.

As shown in FIG. 9, in this embodiment the car terminal 119 includes a retro-reflector and modem unit 141 which comprises a two-dimensional pixel array with a QCSE modulator and a photodetector positioned in each pixel of the array. The retro-reflector and modem unit 141 is connected to a communications control unit 143 which processes electrical signals from the photodetectors to recover information sent by the roadside unit 115, and modulates the reflectivity of the QCSE modulators to convey information to the roadside unit 115.

A processor 145 is connected to the communications control unit 143, a user interface 147, a memory 149, a display 151 and a loudspeaker 153. The driver or a passenger in a car 7 is able to input a request for information, via the user interface 147, to the processor 145 which stores the request in the memory 149 until an optical beam from a roadside unit 115 is detected by the photodetectors. When an incoming optical beam from a roadside unit 115 is detected, the processor 145 initially sends a signal to the communications control unit 143 which causes the QCSE modulators to modulate the incoming optical beam to convey the identification information identifying the corresponding car 7 to the roadside unit 115. The processor 145 then checks the memory 149 for any unsent requests, and if any are present sends a signal to the communications control unit 143 which causes the QCSE modulators to modulate the incoming optical beam to convey the unsent requests to the roadside unit 115. The processor 145 also receives previously requested information via the incoming optical beam and the photodetectors in the retro-reflector and modem unit 141, and either stores the requested information in the memory 149 or displays it on the display 151 or outputs an audio signal via the loudspeaker 153 as appropriate.

In the second embodiment, the retro-reflector and modem unit 141 is located in the car terminal 119 and the emitter and detector array is located in the roadside unit 115 because generally the retro-reflector and modem unit 141 is cheaper and, because there is likely to be more cars 7 than roadside units 115, there is therefore a cost advantage. Further, the retro-reflector and modem unit 141 can be driven by simultaneously driving all the modulator elements, rather than just the modulator element being used for the optical link at any one time, because this does not result in a substantial power burden.

Those skilled in the art will appreciate that the car 7 is able to communicate with more than one roadside unit 115, provided the car 7 is within the field of view of each roadside unit 115, and each roadside unit is able to communicate with more than one car 7 within its field of view. Another reason for locating the retro-reflector and modem unit 141 in the car 7 is that the car 7 typically transmits the same data to all roadside units 115 and therefore, as described above, all the modulator elements can be driven using the same data signal, whereas each roadside unit 115 typically transmits different data to each car 7.

FIG. 10 illustrates the optical components of a third embodiment in which a roadside unit 115 communicates with two cars 7 via respective car terminals 119. Components in FIG. 10 which are the same as corresponding components in the first and second embodiments have been referenced by the same numerals and will not be described again.

As shown in FIG. 10, the emitter and detector array and lens system 29 of a roadside unit 115 communicates with a retro-reflector and modulator unit 27a in one car and a retro-reflector and modulator unit 27b in another car. A signal D₁(IN) is used to phase modulate the output of the VCSEL in the emitter and detector array and lens system 29 corresponding to the angular direction of the retro-reflector and modulator unit 27a, and a signal D₂(IN) is used to amplitude modulate the output of the VCSEL corresponding to the angular direction of the retro-reflector and modulator unit 27b. In the retro-reflector and modulator unit 27a, the modulated light beam passes through a telecentric lens system formed by the lens 55a and the stop 57a and is focussed onto an element of the detector/modulator array 51a which detects the amplitude-modulated light beam to recover the signal D₁(IN) and returns a reflected optical beam which is amplitude-modulated by a data signal D₁(OUT). Similarly, in the retro-reflector and modulator unit 27b, the modulated light beam passes through a telecentric lens system formed by the lens 55b and the stop 57b and is focussed onto an element of the detector/modulator array 51b which detects the modulated light beam to recover the signal D₂(IN) and returns a reflected optical beam which is amplitude-modulated by a data signal D₂(OUT).

The reflected optical beams from the retro-reflector and modulator units 27a and 27b are directed back to the emitter and detector array and lens system 29 where they are focussed on respective photodetectors in the detector array 35 to recover the signals D₁(OUT) and D₂(OUT). Therefore, because each emitter in the emitter array 33 and detector in the detector array 35 maps to a corresponding direction, separate communication links with two or more different car terminals can be simultaneously maintained.

Those skilled in the art will appreciate that, in the second and third embodiments, because the amplitude of the light beam emitted by a VCSEL is modulated to convey information from a roadside unit to a car 7, and the amplitude of an optical beam is modulated by a modulator element to convey information from the car 7 to the roadside unit 115, a half duplex (rather than a full duplex) communications link is established in which separate time intervals are allocated to the transmission of data from the car 7 to the roadside unit 115 and the transmission of data from the roadside unit 115 to the car 7. International Patent Application No PCT/GB/00/02632 (which is hereby incorporated by reference) describes techniques which can be applied to the systems in embodiments 2 and 3 to allow full duplex communication.

In the first to third embodiments, the roadside units are positioned on dedicated posts 17 by the edge of the road. The roadside units can also be positioned on existing structures such as bridges or traffic monitoring equipment. In the case where the roadside units are located at traffic monitoring equipment, advantageously this traffic monitoring equipment can automatically feed traffic data to the input device 11 of the central distribution system to provide the local traffic information. Of course, the roadside units can be co-located with new traffic monitoring equipment as well as existing traffic monitoring equipment.

Further, it is advantageous to position the roadside units at locations where cars are often stationary, for example traffic lights or at a road junction, because the communication links can then frequently be maintained for a longer period of time because cars are within the field of view of the roadside unit for a longer period of time. In addition, the local distribution nodes need not be roadside units positioned by the side of a road, but could also be in car parks or petrol stations.

A high data rate communication link to a road vehicle, such as a car, has many uses in addition to those described in the first to third embodiments, particularly because many people spend the majority of their time within a short distance of their car. FIG. 11 schematically illustrates journeys which are undertaken in a car 7. As shown in FIG. 11, the car 7 could travel between the driver's home 161 and either a bank 163, the driver's workplace 165, a petrol station 167 or the office of a client 169.

A fourth embodiment of the invention will now be described with reference to FIG. 12 in which the bank 163 has a bank terminal including an optical communication device identical to that in the roadside units in the second and third embodiments, but connected to a secure system storing account information instead of the central distribution system 101. An advantage of using low divergence optical beams to convey data is that the resulting communication link is more secure than other remote free space communication links, such as radio links and high divergence optical links, because it is difficult for eavesdroppers to intercept the data without being detected. In particular, in a retro-reflecting system the terminal generating the optical beam is able to monitor the strength of the signal received from the retro-reflecting terminal, and is therefore able to detect if any of the optical beam is being diverted by an eavesdropper.

In the fourth embodiment, the car 7 stores a number of credits which can be used in place of cash to pay for purchases. FIG. 12 is a flow chart for a transaction to obtain credits from a bank over an optical link between the car terminal 19 and the bank terminal. In order for the transaction to take place, the car 7 is positioned within the field of view of the optical communication device at the bank terminal so that the light beam emitted by the bank terminal is retro-reflected by the car terminal and the optical link is established.

The transaction starts with a user in the car 7 transmitting, in step S1, a request to the secure system in the bank 163 over the optical link including both identification details of the user and the number of credits requested. The secure system receives the request in step S3 via the bank terminal and determines, in step S5, the balance of the account corresponding to the user identification details.

The secure system then checks, in step S7, that the user's account has at least the requested number of credits. If the user's account does have the requested number of credits, the transaction proceeds to step S9 in which the requested number of credits are transmitted over the optical link from the bank terminal to the car terminal, which receives and stores the requested number of credits in step S11 and the transaction ends. If the user's account does not have enough credits, the transaction proceeds to step S13 in which an indication that the account has insufficient funds is transmitted over the optical link from the bank terminal to the car terminal, which receives the indication of insufficient funds in step S15 and the transaction ends. Those skilled in the art will realise that transmitting credits over an optical link, as in step S9, involves transmitting an authorisation code to increase a tally number, stored in the car 7, which indicates the number of credits stored in the car 7 by the requested number of credits and consequently subtracting the requested number of credits from the user's account at the bank 163.

The credits stored in the car 7 in the fourth embodiment can be used to purchase any item. Further, the car 7 can also be used to store financial details of a credit agreement between the driver of the car 7 and a credit provider, i.e. the car 7 can take the place of a credit card as well as take the place of cash.

A fifth embodiment will now be described with reference to FIGS. 13 to 15 in which the credits and financial details stored in the car 7 are used to carry out purchases at the petrol station 167. In particular, in the fifth embodiment the credits are used to purchase petrol and multimedia data conveying, for example, films or music. In the fifth embodiment, components which are identical to corresponding components in the first to fourth embodiments have been referenced with the same numerals and will not be described again.

As shown in FIG. 13, the car 7 in the fifth embodiment has the same structure as the car 7 of the second embodiment. The display 151 and loudspeaker 153 provide a multimedia entertainment system over which purchased films and music can be played to provide in-car entertainment. In this embodiment, the memory 149 also stores the tally number indicating the number of credits stored in the car 7 and the financial details for the credit agreement.

The petrol station 167 includes a main building 181 and a pump 183 which provides petrol for the car 7. As shown in FIG. 13, the main building 181 of the petrol station 167 houses a controller 185 which is connected to a database 187 storing films and music in electronic data format, a billing unit 189, a communications unit 191 and a modem 193. The billing unit 189 is connected to the pump 183 by a copper wire link and calculates the total cost of the purchase of the petrol, films and/or music. The billing unit includes a dedicated link to the credit provider of the credit agreement so that approval of a transaction under the credit agreement can be obtained from the credit provider. The modem 193 enables the controller 185 to download information over the internet to update the database 187, or to obtain requested multimedia data which is not stored in the database 187.

The communications unit 191 includes an emitter and detector array and lens system 29, an amplifier 37, a filter 39, a clock recovery and data retrieval unit 41 and a drive signal generator 137 arranged as shown in FIG. 8, with the controller 185 taking the place of the CPU 131. Therefore, the communications unit is able to output a low divergence free space optical beam which can be steered within a field of view, which in this embodiment encompasses the region around the pump 183 in which the car 7 is parked when refuelling with petrol from the pump 183. When the optical beam output by the main building 181 is incident on the retro-reflector and modem unit 141, it is modulated and reflected back to the communication unit 191 to establish an optical link 195. Once the optical link 195 is established a transaction can take place.

The format of a transaction in which a user in the car 7 purchases petrol and a film using the credits stored in the car 7 will now be described with reference to FIG. 14. The transaction commences with a user in the car 7 transmitting, in step S21, a purchase request to the main building 181 of the petrol station 167, which involves the user entering details of the film in the user interface 147 and the processor 145 causing the retro-reflector and modem unit 141 to modulate the optical beam received from the communication unit 191 in accordance with a data signal conveying a request to buy petrol and a film along with the details of the film and an indication that payment will be made using credits.

The modulated optical beam is then received by the communication unit 191 in step S23 and conveyed to the controller 185 which, in step S25, causes the billing unit 189 to determine the required number of credits to pay for the petrol and the film. An indication of the required number of credits is then, in step S27, transmitted from the controller 185 to the processor 145 of the car 7 over the optical link.

The indication of the required number of credits is received, in step S29, by the processor 145 which responds by transmitting, in step S31, the required number of credits from the memory 149 to the controller 185 over the optical link 195. In step S33, the controller 185 receives the credits and then, in step S35, checks that the received number of credits are sufficient, i.e that the received number of credits is equal to the required number of credits. If the received number of credits are sufficient, the transaction proceeds to step S37 in which the controller 185 sends an acknowledgement of receipt of the credits together with the multimedia data corresponding to the requested film, which the controller has accessed from either the database 187 or the internet, to the processor 145 in the car 7 over the optical link 195, and the processor 145 receives the acknowledgement in step S39, stores the multimedia data corresponding to the requested film in the memory 149, and the transaction ends. However, if the received number of credits is not sufficient, the transaction proceeds to step S41 in which the controller 185 sends an indication that the transaction is cancelled to the processor 145 in the car 7, and the processor 145 receives the indication of cancellation in step S43 and the transaction ends.

Those skilled in the art will appreciate that the transmission of credits in step S31 above comprises sending an indication of a number of credits, and if acknowledgement is received this number is subtracted from the tally number stored in the memory 149. If, however, the transaction is cancelled, then the number of credits transferred is not subtracted from the tally number stored in the memory 149.

The format of a transaction in which a user in the car 7 purchases petrol and a film under the credit agreement using the financial details stored in the car 7 will now be described with reference to FIG. 15. The transaction commences with a user in the car 7 transmitting, in step S51, a purchase request to the main building 181 of the petrol station 167, which involves the user entering details of the film in the user interface 147 and the processor 145 causing the retro-reflector and modem unit 141 to modulate the optical beam received from the communication unit 191 in accordance with a data signal conveying a request to buy petrol and a film along with the details of the film and an indication that payment will be made under the credit agreement.

The purchase request is then received, in step S53, by the controller 185 which responds by transmitting, in step S55, a request for financial details of the credit agreement to the processor 145 in the car 7 over the optical link 195. The processor 145 receives, in step S57, the request for financial details and responds by transmitting, in step S59, the requested financial details to the controller 185.

The controller 185 receives, in step S61, the requested financial details and then performs a credit check in step S63. The credit check involves the controller 185, via the billing unit 189, sending a signal to the credit provider over the dedicated link to obtain confirmation that the credit provider approves the transaction. If the credit provider approves, the transaction proceeds to step S65 where the controller transmits an acknowledgement of the purchase and the electronic data corresponding to the requested film to the processor 145 over the optical link. The processor 145 then receives the acknowledgement and electronic data, in step 67, and stores the electronic data in the memory 149 and the transaction ends. If, however, the credit provider does not approve then the transaction proceeds to step S69 in which the controller 185 transmits an indication that the transaction is cancelled to the processor 145 in the car 7, which receives the indication of cancellation in step S71 and the transaction ends.

Although the multimedia data can be played using the display 151 and loudspeaker 153 in the car 7, alternatively the car could simply be used to transfer the multimedia data to a different location where it is transferred to a device external to the car 7 for playing. This is particularly advantageous when the multimedia data is transferred to a location where there is not an existing high bandwidth link because it avoids the requirement of downloading the multimedia data using a low bandwidth link which can take a long time.

Using optical links as described above, the amount of music stored in a compact disc will take about 5.2 seconds to download if the optical link transfers data at a rate of 1 Gigabit per second, and a two hour film will take about 38.5 seconds to download. While one Gigabit per second is an entirely feasible data rate, the system could also be operated at data rates of around 100 megabits per second in order to take advantage of cheaper electronic circuitry. At 100 megabits per seconds, it will take about 50 seconds to download the music stored on a compact disc and about six and half minutes to download a two hour film.

A sixth embodiment will now be described with reference to FIG. 16 in which multimedia data, downloaded from the petrol station 167 as described in the fifth embodiment, is transported by the car 7 to the driver's home 161. In the sixth embodiment, components which are identical to corresponding components in the first to fifth embodiments have been referenced with the same numerals and will not be described again.

As shown in FIG. 16, the home 161 houses a central server 201 which is linked to a plurality of optical distribution nodes 203a to 203c within the home 161. The central server 201 is also connected to a communication unit 191 which is positioned so that when the car 7 is parked in a garage (not shown), an optical link 207 can be established between the car 7 and the central server 201 so that multimedia data stored in the memory 149 in the car 7 can be transferred to the central server 201.

Each of the optical distribution nodes is connected to a number of devices 205a to 205g which can be used to play the multimedia data, for example televisions and multimedia computers. The central server 201 is therefore able to transmit the multimedia data downloaded from the car 7 to one or more devices 205 using one or more optical distribution nodes 203. In this embodiment, the links between the optical distribution nodes 203 and the devices 205 employ the same optical link technology as described in the second embodiment between the roadside unit 15 and the car terminal 19 and will therefore not be described again.

### MODIFICATIONS AND FURTHER EMBODIMENTS

A number of embodiments have been described above in which data is transmitted to and received from a computer system provided in a road vehicle using an optical link. These embodiments have a number of advantageous features which include:

(1) The use of a low divergence optical beam for the optical link requires less power than a high divergence optical beam because the intensity of the beam is concentrated.

(2) The ability to vary the direction of the low divergence optical beam automatically, i.e. not manually, within a broad field of view is particularly advantageous when setting up an optical link to a road vehicle because it alleviates the problem of how to align the low divergence optical beam on fairly small targets. It also allows data to be transferred to a moving vehicle.

(3) The use of a VCSEL emitter array and a telecentric lens system is a particularly advantageous way to vary the direction of the low divergence optical beam because each VCSEL emitter then emits an optical beam to a corresponding region in the field of view and the telecentric lens transmits the optical beams from the VCSEL emitters with comparable collection efficiencies.

(4) The use of a retro-reflecting terminal is advantageous because it reduces the number of optical emitters required and therefore reduces the power requirements for the optical link.

(5) The use of a modulator array and a telecentric lens system in the retro-reflector terminal allows planar semiconductor fabrication techniques to be used to manufacture the modulator array because incoming optical beams are substantially perpendicularly incident on all the modulator elements and therefore are reflected back along the direction of incidence. Further all the modulator elements operate with a similar modulation efficiency.

(6) The use of a low divergence optical beam is particularly suitable for conveying confidential information because it is difficult to intercept without being detected.

(7) The use of a low divergence optical beam enables a high bandwidth communications link to be established with a road vehicle and therefore a large amount of data can be transmitted in a short time.

(8) The ability to download data into a road vehicle allows a driver to transport data generated at a first location to a second location where the data can be accessed from the road vehicle.

(9) The use of a road vehicle to transport data between two locations provides more security than transporting data over a communications network such as the internet.

Examples of situations where it is advantageous for a driver to transport data in a car is to transport data from the driver's workplace 165 to the driver's home 161 or a client's office 169, particularly if the data is confidential.

Those skilled in the art will appreciate that the security of the low divergence optical beam can advantageously be used for data links which are not for the transfer of data to and from a road vehicle, and could be used, for example, for data links between buildings. The low divergence optical links described above can also be used, for example, in the petrol station 67 between the pump 183 and the billing unit 189.

In the first to third embodiments, the roadside units accessed data from a central distribution system. However, some data particular to individual roadside units could be stored at the roadside units. For example, each roadside unit could store the speed limit of the adjacent road for transmission to cars driving along the adjacent road.

In the second and third embodiments, a request was transmitted from the car 7 to the roadside unit 15 over the same optical link as data received from the roadside unit 15. Alternatively, because the request would typically not contain a large amount of data, a radio communications link could be used to transmit the request from the car 7 to the roadside unit 15.

In the second and third embodiments, the car 7 need not be connected to a stand-alone network linked to the roadside units 15, but could alternatively be connected to other networks such as the internet. Further, the communication links could be used for the transfer of electronic mail (e-mail) to and from the car 7. In an embodiment, the car 7 could include a global positioning system (GPS) receiver which determines the position of the car 7 and this position can be transmitted to the roadside unit 15 which responds by sending local information for that position.

The credit payment system described in the fourth and fifth embodiments is particularly well suited to payment of tolls to travel along a stretch of road, over a bridge, through a tunnel or the like.

In the previously described embodiments, separate emitter and detector arrays, which were optically co-located using a beam splitter, were used. Those skilled in the art will appreciate that any differences between the pixel spacings in the emitter and detector arrays can be compensated for using additional optics.

FIG. 17 illustrates an alternative arrangement in which the emitter and detector arrays are physically co-located. As shown in FIG. 17, each pixel cᵢⱼ of the array 211 includes an emitter element eᵢⱼ adjacent to a detector element dᵢⱼ. Light returned from the retro-reflector forms a light spot 213 which covers both the emitter element eᵢⱼ and the detector element dᵢⱼ.

A number of arrangements are described in International Patent Application No. PCT/GB00/02688 (the contents of which are incorporated herein by reference) to improve the packing density of the emitter and detector arrays to achieve better coverage within the field of view.

In the previously described embodiments, the modulator and the detector arrays in the retro-reflector and modem unit were integrated on the same substrate. Alternatively, separate modulator and detector arrays could be employed with a beam splitter being used to optically co-locate the modulator array and the detector array.

As described above, the direction of the low-divergence optical beam is varied by selectively addressing different VCSELs in the emitter array. FIGS. 18 to 20 illustrate an alternative direction varying mechanism utilising mirrors to steer the optical beam. In particular, the system described in FIGS. 18 to 20 is used to establish a secure communication link between a first building 303 and a second building 307.

FIG. 18 schematically illustrates the main components of the optical communication devices at the first building 303 and the second building 307 using the mirror steering mechanism. As shown in FIG. 18, the first building 303 comprises a communications control unit 311 which (i) receives the optical signals transmitted along an optical fibre bundle 305; (ii) regenerates data from the received optical signals; (iii) receives messages 312 transmitted from the second building 307 and takes appropriate action in response thereto; and (iv) converts the regenerated data into data 314 for modulating the respective light beams 315 received from the second building 307. In converting the regenerated data into modulation data 314, the communications control unit 311 will encode the regenerated data with error correction coding and coding to reduce the effects of inter-symbol-interference and other kinds of well known sources of interference such as from the sun and other light sources.

The first building 303 also comprises a retro-reflector and modem unit 313, which is arranged to receive the beam 315 from the second building 307, to modulate the light beam 315 with the appropriate modulation data 314 and to reflect the modulated light beam back to the second building 307. In the event that an optical beam 315 received from the second building 307 carries a message 312, then the retro-reflector and modem unit 313 retrieves the message 312 and sends it to the communications control unit 311 where it is processed and the appropriate action is taken. In this embodiment, the retro-reflector and modem unit 313 has a field of view of +/−40° in both the horizontal and vertical directions.

FIG. 18 also shows the main components at the second building 307. As shown, the second building 307 comprises a laser diode 317 for outputting a laser beam 319 of coherent light. In this embodiment, the second building 307 is designed to communicate with the first building 303 within a range of approximately 200 meters with a link availability of 99.9 per cent. To achieve this, the laser diode 317 is a 150 mW laser diode which outputs a laser beam having a wavelength of 850 nm. Although this is well above the operating limit which is classified as eye safe, this embodiment makes use of the fact that, after the optical link is initially aligned, if the laser beam is interrupted by a person, then this will be detectable at the receiver (since such an interruption of the beam causes an almost instantaneous drop in received signal level) and hence in this situation, the power output of the laser can be reduced to safe levels.

As shown in FIG. 18, the output laser beam 319 is passed through a collimator 321 which reduces the angle of divergence of the laser beam 319. The resulting laser beam 323 is passed through a beamsplitter 325 to a pair of steerable mirrors 326 which are used to steer the laser beam. The laser beam then passes through an optical beam expander 327, which increases the diameter of the laser beam to approximately 50 mm for transmittal to the retro-reflector and modem unit 313 located in the local distribution node 303. The optical beam expander 327 is used because a large diameter laser beam has a smaller divergence than a small diameter laser beam.

Using the optical beam expander 327 has the further advantage that it provides a fairly large collecting aperture for the reflected laser beam and it concentrates the reflected laser beam into a smaller diameter beam. The smaller diameter reflected beam is then split from the path of the originally transmitted laser beam by the beamsplitter 325 and focussed onto a photo-diode 329 by a lens 331. Since the operating wavelength of the laser diode 317 is 850 nm, a silicon avalanche photo-diode (APD) can be used, which is generally more sensitive than other commercially available photo detectors, because of the low noise multiplication which can be achieved with these devices. The electrical signals output by the photo-diode 329, which will vary in dependence upon the modulation data 314, are then amplified by the amplifier 333 and filtered by the filter 335. The filtered signals are then supplied to a control unit 337 which regenerates the clock and the video data using standard data processing techniques. The retrieved data 338 is then passed to the user unit 339, which, in this embodiment, comprises a display.

The control unit 337 is also used to control the steering of the steerable mirrors 326 so that the laser beam is optimally aligned with the local distribution node 303. The control unit 337 also monitors and keeps a history of the recent signal strength so that, if the beam is interrupted, it can pass a control signal to the laser control unit 341 so that the power of the laser diode 317 is reduced to a class 1 level (0.25 mW). Provided this power reduction can be achieved within one millisecond of the beam being interrupted, this would provide a system which could be considered as class 1 eye safe. As those skilled in the art will appreciate, by monitoring the recent history of the received signal strength, the control unit 337 can distinguish between slowly varying signal levels (caused for example by deteriorating atmospheric conditions) and sudden interruptions caused by, for example, a person interrupting the beam.

In this embodiment, the user unit 339 can receive financial details input by the user, for example indicating credit card details. In response, the user unit 339 generates an appropriate message 312 for transmittal to the first building 303. This message 312 is output to the laser control unit 341 which controls the laser diode 317 so as to cause the laser beam 319 output from the laser diode 317 to be modulated with the message 312.

The way in which the laser beam is steered by the steerable mirrors 326 will now be described with reference to FIGS. 19 and 20. FIG. 19 is a perspective schematic view of the components in the second building 307 shown in FIG. 18. As shown, light from the laser diode 317 passes through the collimator lens 321 and through a beamsplitter 325 to the steerable mirrors 326-1 and 326-2. As shown, steerable mirror 326-1 is mounted for rotation on the drive shaft 381-1 of motor 383-1 and can therefore be rotated about the vertical axis 385 of the shaft 381-1. The mirror 326-1 can therefore be used to steer the laser beam horizontally. As shown in FIG. 19, the laser beam reflected from the mirror 326-1 hits the mirror 326-2 which is mounted for rotation with the drive shaft 381-2 of the second motor 383-2. As shown, the drive shaft 381-2 is operable to rotate the mirror 326-2 about the horizontal axis 387. As a result, the mirror 326-2 can steer the laser beam in the vertical direction. Consequently, the combination of the two mirrors 326-1 and 326-2 can steer the laser beam towards the retro-reflector and modem unit 313 in the first building. In this embodiment, the control unit 337 controls the positions of the mirrors 326-1 and 326-2 by outputting appropriate control signals to the motors 383-1 and 383-2. In particular the control unit 337 controls the motors 383 in order to maximise the level of the signal reflected from the first building 303. In order that the control unit 337 can detect this and determine the correct direction in which to steer the beam for maximum strength, it uses a phase sensitive detection technique. This is achieved by applying a small amplitude oscillation to each of the two mirrors 326-1 and 326-2. The resulting small modulation in the received signal strength (due to the oscillation of the mirrors) is detected by mixing the received signal with the modulating signal applied to the motors 383-1 and 383-2 used to cause the mirrors to oscillate. This is illustrated in FIG. 20.

In particular, FIG. 20 shows a dither signal generator 391 which generates the modulating signals used to cause the two mirrors 326 to oscillate. In this embodiment, dither signal generator 391 generates two dither signals 393-1 and 393-2 which are passed to a motor controller 395. The motor controller 395 uses the dither signal 393-1 to control the motor 383-1 and it uses the dither signal 393-2 to control the motor 383-2. The signal 397 output from the filter 335 (shown in FIG. 18) is input to two mixers 399-1 and 399-2 where the signal is mixed with a respective one of the two dither signals 393-1 and 393-2. As those skilled in the art will appreciate, the two dither signals 393-1 and 393-2 are preferably at different frequencies which are not harmonically related, in order that there is no cross talk between the signals derived from the respective mixers 399-1 and 399-2. The outputs from the mixers 399 are then filtered by a respective low pass filter 401-1 and 401-2 to remove the high frequency components. The filtered signals are then converted into digital signals by the analogue to digital converter 403 and then passed to the microprocessor 405 for processing.

The microprocessor 405 processes the signals output by the analogue to digital converter 403 and outputs an appropriate control signal to the motor controller 395 to cause the mirrors 326 to be adjusted so that the beam is optimally aligned with the retro-reflector.

FIG. 20 also shows that the control unit 337 includes a clock recovery and data regeneration unit 407 which is used to regenerate the modulation data 314 sent from the first building 303. As shown, this data is output to the user unit 339. FIG. 20 also shows that the signal 397 is input directly to the microprocessor 405, via the analogue to digital converter 403, so that the microprocessor 405 can (i) continuously monitor the signal strength of the received beam; (ii) store, in the memory 409, the recent history of the received signal strength; and (iii) if appropriate, output a control signal to the laser control unit 341 in order to reduce the power of the transmitted laser beam.

A number of further modifications to the embodiment described with reference to FIGS. 18 to 20 are outlined in International Patent Application No. PCT/GB00/02633, the whole contents of which are incorporated herein by reference.

As described above, one of the advantages of using a retro-reflecting arrangement is that the terminal having the light source can monitor the retro-reflected light beam and can reduce the power level of the emitted light beam to eye-safe levels if the retro-reflected light beam is interrupted. This can, of course, only take place when the emitted light beam has been aligned onto the retro-reflector. In an embodiment, the power level of the emitted light beam is maintained at eye safe levels during the alignment process to minimise any possible danger to people and animals.

In the embodiments described above employing a VCSEL emitter array, during the alignment process the elements of the array are individually addressed in order to scan the light beam throughout the field of view. Alternatively, all of the VCSEL emitter elements could be addressed simultaneously, or the VCSEL array could be split into groups of VCSEL emitter elements and the groups of VCSEL emitter elements could be sequentially addressed.

The illustrated embodiments all utilised a retro-reflector and modem unit which modulated an incoming laser beam from an emitter and detector array using an array of QCSE devices and reflected the modulated laser beam back to the emitter and detector array. However, as described in International Patent Application WO 98/35328, other retro-reflecting systems could be used in which an incoming optical beam is modulated and then reflected, or alternatively reflected and then modulated. Alternatively, as described in International Patent Application WO 00/48338 (which is incorporated herein by reference), the reflector and modem unit could be replaced by a second emitter and detector array.

Alternatively, as described in International Patent Application No PCT/GB00/02632, since the QCSE modulator is formed by a p-i-n node, the QCSE modulator can also be used to detect the amount of incident light.

A signalling device for the system described above could be incorporated in a laptop computer or electronic personal organiser storing financial details.

Although the embodiments described above have used laser beams with a wavelength of about 850 nm, those skilled in the art will appreciate that other wavelengths could be used. In particular, a wavelength of about 1.5 microns is an attractive alternative because it is inherently more eye-safe and cheap emitters and detectors have been developed for optical fibre telecommunications.

As described above, the invention provides a high bandwidth optical data link. In particular, the invention relates a data link for transmitting data at a rate in excess of 1 kilobit per second, with the preferred data rate to be in the region of 5 Gigabits per second.

1. A signalling system comprising first and second signalling devices movable relative to each other, wherein the second signalling device is mounted to a moveable vehicle,
wherein one of said first and second signalling devices comprises: (i) a light source for emitting a light beam; (ii) a lens system for collecting the light beam emitted by the light source and directing the light beam in an exit direction within a field of view of the lens system; (iii) a first detector for detecting the presence of the other signalling device within the field of view; and (iv) means for varying the exit direction within the field of view to enable alignment of the optical beam with said other signalling device, and
wherein the first signalling device comprises a modulator for modulating the light beam in accordance with data to be sent to said vehicle, and the second signalling device comprises: a second detector for detecting the modulated light beam and for converting the modulated light beam into a corresponding electrical signal; and means for processing the electrical signal to recover said data.

2. A signalling system according to claim 1, wherein said light source comprises a plurality of light emitting elements, and said lens system is arranged to direct light from each of the light emitting elements in a respective different direction.

3. A signalling device according to claim 2, wherein said varying means comprises means for selectively addressing each of the plurality of light emitting elements.

4. A signalling system according to either claim 2 or 3, wherein the plurality of light emitting elements are arranged in a regular array.

5. A signalling system according to any of claims 2 to 4, wherein one or more of the plurality of light emitting elements comprises a vertical cavity surface emitting laser.

6. A signalling system according to claim 5, wherein the modulator is operable to modulate a drive current applied to the vertical cavity surface emitting laser in accordance with said data.

7. A signalling system according to any preceding claim, wherein the lens system comprises a telecentric lens system.

8. A signalling system according to any preceding claim, wherein the first detector comprises a plurality of detecting elements, each detecting element arranged to detect light from a respective region within said field of view.

9. A signalling system according to claim 8, wherein the plurality of detecting elements are arranged in a regular array.

10. A signalling system according to either claim 8 or 9, wherein the varying means is arranged to vary the exit direction in accordance with which of the detecting elements detects the presence of said other signalling device.

11. A signalling system according to claim 8 when dependent upon claim 2, wherein each light emitting element of said light source is associated with a respective one of the light detecting elements of the first detector, such that an associated light emitting element and light detecting element pair are substantially optically co-located relative to said lens system.

12. A signalling system according to claim 11, wherein an associated light emitting element and light detecting element pair are located adjacent to each other.

13. A signalling system according to claim 11, wherein the plurality of light emitting elements and the plurality of light detecting elements are located separately from each other, and wherein a beam splitter is provided in order to co-locate optically the associated light emitting element and light detecting element pairs with respect to said lens system.

14. A signalling system according to any of claims 11 to 13, wherein said lens system comprises a telecentric lens and wherein at least one of the plurality of light emitting elements and the plurality of light detecting elements are located substantially at a focal plane of the telecentric lens.

15. A signalling system according to any preceding claim, wherein said one signalling device is the first signalling device and said other signalling device is the second signalling device, and wherein said modulator is operable to modulate the light beam emitted by the light source in accordance with said data.

16. A signalling system according to claim 15, wherein:
said second signalling device further comprises a light reflector for reflecting the light beam received from the first signalling device back to the first signalling device in order to indicate the presence of the second signalling device;
said first detector of the first signalling device is operable to determine the direction of incidence of the reflected light beam; and
said varying means is arranged to vary the exit direction in accordance with the direction of incidence of the reflected light beam.

17. A signalling system according to claim 16, wherein said light reflector comprises a retro-reflector.

18. A signalling system according to either claim 16 or 17, wherein said light reflector comprises a mirror.

19. A signalling system according to any of claims 15 to 17, wherein the modulator of the first signalling device is a first modulator, and the second signalling device comprises a second modulator for modulating the light beam emitted from the light source in accordance with additional data.

20. A signalling system according to claim 19, wherein said second modulator and said light reflector are formed as a single unit.

21. A signalling device according to claim 20, wherein the single unit comprises an array of modulating and reflecting elements.

22. A signalling device according to claim 20 or 21, wherein the single unit comprises at least one quantum confined Stark effect device.

23. A signalling system according to claim 22, wherein the second modulator is operable to modulate a voltage applied to the or each quantum confined Stark effect device, thereby modulating the reflectivity of the quantum confined Stark effect device, in accordance with said additional data.

24. A signalling device according to any of claims 16 to 23, wherein said lens system of the first signalling device is a first lens system, and the second signalling device further comprises a second lens system for collecting the light beam emitted from said light source of the first signalling device and for directing the collected light to the light reflector.

25. A signalling device according to claim 24, wherein said second lens system is a telecentric lens system and said light reflector is located substantially at a focal plane of the second lens system.

26. A signalling system according to claim 15, wherein:
said light source is a first light source for emitting a first light beam, said modulator is a first modulator, said lens system is a first lens system
said second signalling device further comprises: a second light source for emitting a second light beam; a second lens system for collecting the second light beam and directing the second light beam in a corresponding exit direction; and a second modulator for modulating the second light beam in accordance with additional data to be transmitted to the first signalling device.

27. A signalling system according to claim 26, wherein a plurality of said first signalling devices are provided at respective positions throughout a geographical area.

28. A signalling system according to claim 27, wherein the plurality of said first signalling devices are located in the vicinity of respective stretches of road.

29. A signalling system according to claim 27 or 28, wherein the plurality of first signalling devices are connected to a central distribution system operable to transmit to each first signalling device information associated with the region of the geographical area in which the first signalling device is located.

30. A signalling system according to claim 29, wherein said information comprises traffic information.

31. A signalling system according to claim 26, wherein the first signalling device is located at a vehicle refuelling facility.

32. A signalling system according to claim 31, wherein said first signalling device is connected to a data store, said second signalling device is operable to transmit to the first signalling device a request for data from the data store, and said first signalling device is operable to receive said request, retrieve the requested data from the data store and transmit the requested data to the second signalling device.

33. A signalling system according to claim 32, wherein the data store is located at the vehicle refuelling facility.

34. A signalling system according to claim 32, wherein the data store is remote from the vehicle refuelling facility, and said first signalling device is connected to the vehicle refuelling facility via a computer network.

35. A signalling system according to claim 26, wherein the first signalling device is located in a car parking area.

36. A signalling system comprising first and second signalling devices movable relative to each other, wherein the first signalling device is mounted to a moveable vehicle,
wherein one of said first and second signalling devices comprises: (i) a light source for emitting a light beam; (ii) a lens system for collecting the light beam emitted by the light source and directing the light beam in an exit direction within a field of view of the lens system; (iii) a first detector for detecting the presence of the other signalling device within the field of view; and (iv) means for varying the exit direction within the field of view to enable alignment of the optical beam with said other signalling device, and
wherein the first signalling device comprises a modulator for modulating the light beam in accordance with data to be sent to the vehicle, and the second signalling device comprises a second detector for detecting the modulated light beam and for converting the modulated light beam into a corresponding electrical signal, and means for processing the electrical signal to recover said data.

37. A signalling system according to claim 36, wherein a plurality of said second signalling devices are provided at respective positions throughout a geographical area.

38. A signalling system according to claim 37, wherein the plurality of said second signalling devices are located in the vicinity of respective stretches of road.

39. A signalling system according to claim 37 or 38, wherein the plurality of said second signalling devices are connected to a central distribution system operable to transmit to each second signalling device information associated with the region of the geographical area in which the second signalling device is located.

40. A signalling system according to claim 39, wherein said information comprises traffic information.

41. A signalling system according to claim 36, wherein the second signalling device is located at a vehicle refuelling facility.

42. A signalling system according to claim 41, wherein said second signalling device is connected to a data store, said first signalling device is operable to transmit to the second signalling device a request for data from the data store, and said second signalling device is operable to receive said request, retrieve the requested data from the data store and transmit the requested data to the first signalling device.

43. A signalling system according to claim 42, wherein the data store is located at the vehicle refuelling facility.

44. A signalling system according to claim 42, wherein the data store is remote from the vehicle refuelling facility, and said second signalling device is connected to the vehicle refuelling facility via a computer network.

45. A signalling system according to claim 36, wherein the second signalling device is located in a car parking area.

46. A signalling system comprising first and second signalling devices movable relative to each other, wherein the second signalling device is mounted to a moveable vehicle,
wherein said first signalling devices comprises: (i) a light source comprising a two-dimensional array of light emitting elements, each light emitting element being selectively addressable to emit a respective light beam; (ii) a first detector comprising a two-dimensional array of light detecting elements; (iii) a lens system, wherein the light source and the first detector are optically co-located relative to the lens system such that each light beam emitted by said light source is collected by the lens system and directed in an outgoing direction within a field of view of the lens system corresponding to the light emitting element which emitted the light beam, and an incoming light beam from the second signalling device, incident on the first signalling device from an incoming direction, is directed to the first detector where the incoming light beam is detected by one of the plurality of light detecting elements which corresponds to the incoming direction, thereby determining the incoming direction; (iii) a selector operable to select the light emitting element having an outgoing direction corresponding to the determined incoming direction of an incoming light beam; and (iv) a modulator for modulating the light beam emitted from the selected light emitting element in accordance with data to be sent to said vehicle to form a modulated light beam directed at the second signalling device,
and the second signalling device comprises: (i) a retro-reflector having a planar reflector and a telecentric lens system, wherein the planar reflector is located in a focal plane of the lens system so that the second signalling device is operable to reflect said modulated optical beam from the first optical signalling device back to the first signalling device, thereby forming said incoming beam; (ii) a second detector operable to detect said modulated light beam from the first signalling device and to convert the modulated light beam into a corresponding electrical signal; and (iii) means for processing the electrical signal to recover said data.

47. A signalling system according to claim 46, wherein the light source comprises a two-dimensional array of vertical cavity surface emitting lasers.

48. A signalling system according to claim 46 or 47, wherein the planar reflector comprises a two-dimensional array of quantum confined Stark effect devices, and the second signalling device further comprises a voltage generator operable to modulate the reflectivity of at least one of the quantum confined Stark effect devices in accordance with additional data to be transmitted from the second signalling device to the first signalling device.

49. A vehicle comprising a first signalling device or a second signalling device as claimed in any of claims 1 to 25.

50. A financial transaction system comprising first and second signalling devices,
wherein the first signalling device is associated with a first party to the financial transaction and comprises: a memory for storing data relating to the financial transaction; a modulator for modulating a light beam in accordance with the data stored in said memory; and a lens system for substantially collimating the modulated light beam to form a collimated light beam and directing the collimated light beam in an exit direction,
and wherein the second signalling device is associated with a second party to the financial transaction and comprises: a detector for detecting the collimated light beam from the first signalling device and for converting the collimated light beam into a corresponding electrical signal; and means for processing the electrical signal to recover said data relating to the financial transaction.

51. A financial transaction system according to claim 50, wherein the first signalling device comprises a light source for emitting the light beam modulated by the modulator.

52. A financial transaction system according to claim 51, wherein the light source comprises a plurality of light emitting elements and the lens system is arranged to direct light from each light emitting element in a respective direction.

53. A financial transaction system according to claim 52, wherein the lens system is a telecentric lens system and the plurality of light emitting elements are positioned substantially at a focal plane of the lens system.

54. A financial transaction system according to any of claims 50 to 53, wherein the plurality of light emitting elements comprise an array of vertical cavity surface emitting lasers.

55. A financial transaction system according to claim 50 wherein the second signalling device comprises a light source for emitting the light beam modulated by the modulator.

56. A financial transaction system according to claim 55, wherein the first signalling device comprises a light reflector for reflecting the light beam from the second signalling device back to the second signalling device.

57. A financial transaction system according to claim 56, wherein the light reflector is a retro-reflector.

58. A financial transaction system according to claim 56 or 57, wherein the modulator and the light reflector are formed as a single unit.

59. A financial transaction system according to claim 58, wherein the single unit comprises an array of modulating and reflecting elements.

60. A financial transaction system according to any of claims 50 to 59, wherein the modulator comprises at least one quantum confined Stark effect device.

61. A financial transaction system according to any of claims 56 to 60, wherein the lens system comprises a telecentric lens system and the light reflector is substantially located at a focal plane of the lens system.

62. A financial transaction system according to any of claims 50 to 61, wherein the modulator comprises at least one quantum confined Stark effect device.

63. A financial transaction system according to claim 57, wherein the processing means of the second signalling device is operable to monitor the amplitude of the light beam reflected from the first signalling device, and to abort a financial system in response to a predetermined variation in amplitude.

64. A financial transaction system according to any of claims 50 to 63, wherein one of the first and second signalling devices is located at a vehicle refuelling facility and the other signalling device is mounted to a vehicle.

65. A financial transaction system according to any of claims 50 to 64, wherein the first signalling device further comprises:
one or more mirrors in the path of the light beam, the or each mirror mounted for pivotal movement about a corresponding pivot axis; and
means for moving the or each mirror about the corresponding pivot axis to vary the exit direction of the light beam.

66. A method of transmitting data from a first signalling device to a second signalling device mounted to a vehicle, the method comprising the steps of:
detecting the location of the second signalling device as the vehicle drives through a field of view of the first signalling device using the angle of incidence at the first signalling device of a first substantially collimated beam from the second signalling device;
directing a second substantially collimated light beam at the second signalling device; and
modulating said second light beam in accordance with said data while varying the direction of the second light beam within the field of view in accordance with changes in the angle of incidence of the first light beam so that the light beam remains directed at the second signalling device while the vehicle moves through the field of view, thereby transmitting said data to the second signalling device.

67. A method of transmitting data relating to a financial transaction from a first signalling device to a second signalling device, the method comprising the steps of:
directing a substantially collimated light beam at the second signalling device;
modulating said second light beam in accordance with said data;
reflecting said modulated light beam from the second signalling device to the first signalling device; and
monitoring the reflected light beam at the first signalling device.
